(19) United States
(12) Patent Application Publication
(10) Pub. No.: US 2026/0202656 A1
(43) Pub. Date: Jul. 16, 2026

(54) TWO-PHOTON LIGHT-SHEET MICROSCOPY

(71) Applicant: TRIPLET IMAGING, INC., San Francisco, CA (US)

(72) Inventors: Mackenzie Dion, San Francisco, CA (US); Kevin Keomanee-Dizon, Forked River, NJ (US)

(21) Appl. No.: 19/320,139

(22) Filed: Sep. 5, 2025

Related U.S. Application Data
(60) Provisional application No. 63/745,553, filed on Jan. 15, 2025.
(60) Provisional application No. 63/787,333, filed on Apr. 11, 2025.

(51) Int. Cl. G02B 21/16; G02F 1/35

(52) U.S. Cl. CPC G02B 21/16; G02F 1/3526

(57) ABSTRACT

Systems for irradiating a sample are disclosed. The system includes a light source configured to produce a light beam having a wavelength range to produce a population of excited singlet states derived from relaxation of a population of higher-order triplet states in the sample. The system includes an optical assembly constructed and arranged to converge the light beam to form an optical sheet. The system includes a first objective constructed and arranged to irradiate the sample with the optical sheet. Systems including a visible light source are disclosed. Systems including two light sources are disclosed. Methods of illuminating a sample using a system are also disclosed.

### CROSS REFERENCE TO RELATED APPLICATIONS

This application claims priority to U.S. Patent Application No. 63/745,553, filed Jan. 15, 2025 and U.S. Patent Application No. 63/787,333, filed Apr. 11, 2025, the entire contents of each are incorporated herein by reference in their entirety.

### FIELD OF TECHNOLOGY

Aspects and embodiments disclosed herein relate to systems and methods for generating and measuring fluorescence using light-sheet microscopy.

### SUMMARY

In accordance with an aspect, there is provided a system for irradiating a sample. The system may include a light source configured to produce a light beam having a wavelength range to produce a population of excited singlet states derived from relaxation of a population of higher-order triplet states in the sample. The system may include an optical assembly constructed and arranged to converge the light beam to form an optical sheet. The system further may include a first objective constructed and arranged to irradiate the sample with the optical sheet.

In some embodiments, the light source may be a visible light source. When the light source is a visible light source, the visible wavelength range may be between about 400 nm to about 700 nm.

In some embodiments, the light source may be an infrared (IR) light source. When the light source is an IR light source, the IR wavelength range may be between about 750 nm to about 1000 nm.

In some embodiments, the light source may be a pulsed light source or a continuous-wave light source. For example, the light source, whether pulsed or continuous-wave, may be a fixed wavelength light source. Alternatively, the light source, whether pulsed or continuous-wave, may be a supercontinuum light source. When the light source is a supercontinuum light source, the wavelength range from the supercontinuum light source may be set using a filter. The filter for the supercontinuum light source may be selected from an acousto-optic tunable filter and a linear variable filter.

In some embodiments, the optical assembly may include a cylindrical lens that forms the optical sheet from the light beam.

In some embodiments, the optical assembly may include a Powell lens that forms the optical sheet from the light beam.

In some embodiments, the optical assembly may include one or more scanning mirror galvanometers, e.g., galvos, that form the optical sheet from the light beam and/or translate the sheet orthogonally to the propagation axis of the optical sheet irradiating the sample.

In some embodiments, the optical assembly may include a grating that forms the optical sheet from the light beam.

In some embodiments, the optical sheet can be dithered by an additional mirror galvanometer.

In some embodiments, the optical assembly may include a meniscus or solid-immersion lens.

In some embodiments, the second objective may be disposed above the sample. In this configuration, one or both of a sample stage and the second objective may be constructed and arranged to translate in a direction orthogonal to a beam axis of the optical sheet irradiating the sample.

In some embodiments, the second objective may be disposed below the sample. In this configuration, one or both of a sample stage and the second objective may be constructed and arranged to translate in a direction orthogonal to a beam axis of the optical sheet irradiating the sample.

In further embodiments, the second objective may be disposed on a plane orthogonal to the sample. In this configuration, one or both of a sample stage and the objective may be constructed and arranged to translate in a direction orthogonal to a beam axis of the light beam irradiating the sample.

In further embodiments, the second objective may be disposed on a plane oblique to the sample. In this configuration, one or both of a sample stage and the objective may be constructed and arranged to translate in a direction orthogonal to a beam axis of the light beam irradiating the sample.

In some embodiments, a signal representative of fluorescence in the sample may be collected by the second objective.

In further embodiments, the system may include a second objective constructed and arranged to collect a signal representative of fluorescence in the sample. The second objective may be positioned on a plane orthogonal to the first objective.

In further embodiments, the system may include a detector constructed and arranged to receive the signal representative of fluorescence in the sample and to provide an output representative thereof.

In some embodiments, the population of excited singlet states can be populated by the formation of an initial population of triplet states in the sample upon irradiation by the optical sheet. In particular, the population of excited singlet states can further be populated by further excitation of the initial population of triplet states in the sample to the higher-order triplet states.

In some embodiments, the optical assembly is configured to provide annular pupil illumination via a beam-shaping module that imposes an annular amplitude and/or phase distribution at the pupil to form a propagation-invariant (e.g., a Bessel beam) optical sheet.

In accordance with an aspect, there is provided a method of irradiating a sample. The method may include generating a light beam having a wavelength range chosen to produce a population of excited singlet states derived from relaxation of a population of higher-order triplet states in the sample. The method may include generating an optical sheet from the light beam. The method further may include applying the optical sheet to the sample using an objective to produce a population of triplet states and a population of excited singlet states in the sample.

In further embodiments, the method may include detecting fluorescence from the sample. Detecting fluorescence from the sample may include receiving fluorescent emissions from relaxation of the population of excited singlet states in the sample at a photosensitive detector.

In some embodiments, the light source may be a visible light source. When the light source is a visible light source, the visible wavelength range may be between about 400 nm to about 700 nm.

In some embodiments, the light source may be an IR light source. When the light source is an IR light source, the IR wavelength range may be between about 750 nm to about 1000 nm.

In some embodiments, the light source may be a pulsed light source or a continuous-wave light source. For example, the light source, whether pulsed or continuous-wave, may be a fixed wavelength light source. Alternatively, the light source, whether pulsed or continuous-wave, may be a supercontinuum light source. When the light source is a supercontinuum light source, the wavelength range from the supercontinuum light source may be set using a filter. The filter for the supercontinuum light source may be selected from an acousto-optic tunable filter and a linear variable filter.

In further embodiments, the method may include translating a sample stage or both the second objective and optical sheet to irradiate a different portion of the sample.

In some embodiments, the population of excited singlet states can be populated by the formation of an initial population of triplet states in the sample upon irradiation by the optical sheet. The population of excited singlet states can further be populated by further excitation of the initial population of triplet states in the sample to the higher-order triplet states.

In some embodiments, the optical assembly is configured to provide annular pupil illumination via a beam-shaping module that imposes an annular amplitude and/or phase distribution at the pupil to form a propagation-invariant, e.g., a Bessel beam, optical sheet.

In accordance with an aspect, there is provided a system for irradiating a sample. The system may include a first light source configured to produce a first light beam having a first wavelength range to produce a first population of triplet states in the sample. The system may include a second light source configured to produce a second light beam having a second wavelength range to produce a population of excited singlet states in the sample. The system further may include an optical assembly disposed to combine the first light beam and second light beam to create a combined light beam that forms an optical sheet. The system additionally may include a first objective constructed and arranged to irradiate the sample with the optical sheet.

In some embodiments, the first light source may be a visible light source. In some embodiments, the second light source may be a visible light source.

In some embodiments, the first light source may be a visible light source. In some embodiments, the second light source may be an IR light source,

In some embodiments, the first light source may be an IR light source. In some embodiments, the second light source may be a visible light source.

In some embodiments, the first light source may be an IR light source. In some embodiments, the second light source may be an IR light source.

In some embodiments, the visible wavelength range is between about 400 nm to about 700 nm. In some embodiments, the IR wavelength range may be between about 750 nm to about 1000 nm.

In some embodiments, the optical assembly may include a cylindrical lens that forms the optical sheet from the combined light beam.

In some embodiments, the optical assembly may include a Powell lens that forms the optical sheet from the combined light beam.

In some embodiments, the optical assembly may include one or more scanning mirror galvanometers that form the optical sheet from the light beam and/or translate the sheet orthogonally to the propagation axis of the optical sheet.

In some embodiments, the optical assembly may include a grating that forms the optical sheet from the light beam.

In some embodiments, the optical sheet can be dithered by an additional mirror galvanometer.

In some embodiments, the optical assembly may include a meniscus or solid-immersion lens.

In accordance with an aspect, there is provided a system for irradiating a sample. The system may include a visible light source configured to produce a visible light beam having a visible wavelength range to produce a population of excited singlet states derived from relaxation of a population of higher-order triplet states in the sample. The system may include an optical assembly constructed and arranged to converge the visible light beam to form an optical sheet. The system further may include a first objective constructed and arranged to irradiate the sample with the optical sheet.

In some embodiments, the visible wavelength range may be between about 400 nm to about 700 nm. In specific embodiments, the visible wavelength may be about 660 nm.

In some embodiments, the optical assembly may include a cylindrical lens that forms the optical sheet from the visible light beam.

In some embodiments, the optical assembly may include a Powell lens that forms the optical sheet from the visible light beam.

In some embodiments, the optical assembly may include one or more scanning mirror galvanometers, i.e., galvos, that form the optical sheet from the light beam and/or translate the sheet orthogonally to the propagation axis of the optical sheet.

In some embodiments, the optical assembly may include a grating that forms the optical sheet from the light beam.

In some embodiments, the optical sheet can be dithered by an additional mirror galvanometer.

In some embodiments, the optical assembly may include a meniscus or solid-immersion lens.

In some embodiments, the optical assembly is configured to provide annular pupil illumination via a beam-shaping module that imposes an annular amplitude and/or phase distribution at the pupil to form a propagation-invariant, e.g., a Bessel beam, optical sheet.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various aspects of at least one embodiment are discussed below with reference to the accompanying figures, which are not intended to be drawn to scale. The figures are included to provide illustration and a further understanding of the various aspects and embodiments and are incorporated in and constitute a part of this specification but are not intended as a definition of the limits of the invention. In the figures, each identical or nearly identical component that is illustrated in various figures is represented by a like numeral. For purposes of clarity, not every component may be labeled in every figure. In the drawings:

FIGS. 1A-1C illustrate embodiments of systems for producing and measuring fluorescence in a sample, according to this disclosure; and

FIG. 2 illustrates a flow diagram of an example of a method of producing and measuring fluorescence in a sample, according to this disclosure.

FIGS. 3A-3C illustrates pupil-plane (left of each tile) and corresponding XZ fluorescence projections (right) for Bessel (FIG. 3A), high-NA Gaussian (FIG. 3B), and low-NA Gaussian (FIG. 3C) illumination under 2P′, 2P, and 1P excitation. Illumination NA≈0.2-0.9; ring-NA fraction≈0.6-0.95.

FIGS. 4A-4B illustrate fluorescence-excitation line profiles for the nine illumination modes of FIG. 3. FIG. 4A: intensity versus Z (μm). FIG. 4B: intensity versus X (μm). Center linecuts were taken through the XZ projections. Legends list each mode with its corresponding full width at half maximum (FWHM) for the plotted axis.

### DETAILED DESCRIPTION

Aspects and embodiments are directed to systems and methods for the generation and measurement of fluorescence in suitable molecules using visible and/or IR excitation. The generation and measurement of fluorescence using visible and IR excitation has utility for imaging and stimulation in the life sciences in applications such as microscopy, spectroscopy, and optogenetics without the expensive overhead costs of traditional laser microscopy systems.

Fluorescent molecules, termed fluorophores, emit polarized light, with the polarization direction determined by the fluorophore orientation. Similarly, fluorophores can be excited with laser light, and the probability of excitation depends on the polarization direction of the laser light and the orientation of the fluorophore.

Fluorescence occurs from the excitation of the electric field of fluorophores, resulting in the relaxation from a higher energy excited singlet state to the lower energy singlet ground state, e.g., no change in electron spin multiplicity, by the emission of a photon. In phosphorescence, the electron in the fluorophore which absorbed the incident photon undergoes a radiation less process known as intersystem crossing (ISC) into an energy state of different, and usually higher spin multiplicity known as the triplet state. The transitions from the triplet state are kinetically disfavored, resulting in lingering emissions that persist on the order of milliseconds. While the transition from the ground singlet state to the triplet state is “forbidden,” e.g., there is no allowed way of populating the triplet state T₁ from the ground singlet state S₀ by perturbations of the electric field of the fluorophores, this transition is allowed by excitation of higher-order magnetic dipole transitions in the fluorophores.

Magnetic dipole transitions are orders of magnitude weaker than their electric dipole counterparts and thus have generally not been studied as extensively. Among polarized beams, azimuthally polarized beams have a unique magnetic field feature, i.e., the magnetic field oscillating at optical frequencies, of a strong longitudinal magnetic field where the electric field is null, i.e., the electric field is purely transverse to the beam axis. Without wishing to be bound by any particular theory, the magnetic field at optical frequencies is oscillating in the terahertz (THz) frequency range, exceeding that of the magnetic field from a typical solid-state magnet or electromagnet. The strong magnetic field along the beam axis at optical frequencies with THz oscillations can provide access to the magnetic dipoles of fluorophores to investigate the fluorescent response upon excitation with an azimuthally polarized beam.

Excited triplet states are believed to be the starting point for many possible photochemical reactions leading to phenomena such as blinking or photobleaching. Photobleaching limits the duration and time resolution of experiments and degrades image quality. Although the mechanisms of blinking and photobleaching are not fully understood, it is often assumed that bleaching involves the excited triplet state of the fluorophore and its interactions with the surrounding medium, such as molecular oxygen in air. The reactive oxygen species formed from the interactions of the fluorophore and molecular oxygen are harmful to cells and contribute to phototoxicity. It is an object of the present disclosure to take advantage of direct access to the first excited triplet state and accessible higher-order triplet states Tₙ, n>1 using polarized beams to generate and measure fluorescence in fluorophores and to understand the mechanisms that contribute to photobleaching and phototoxicity.

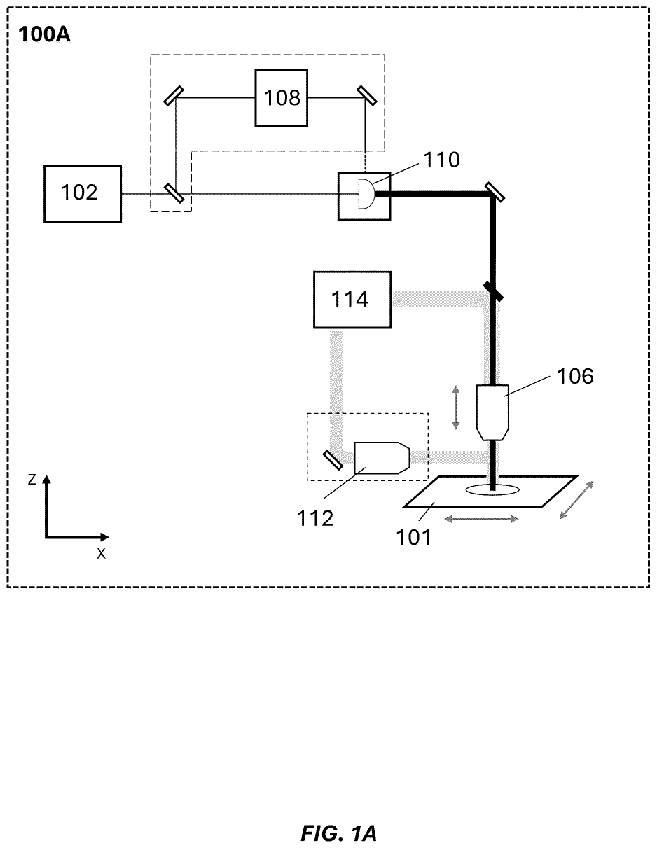

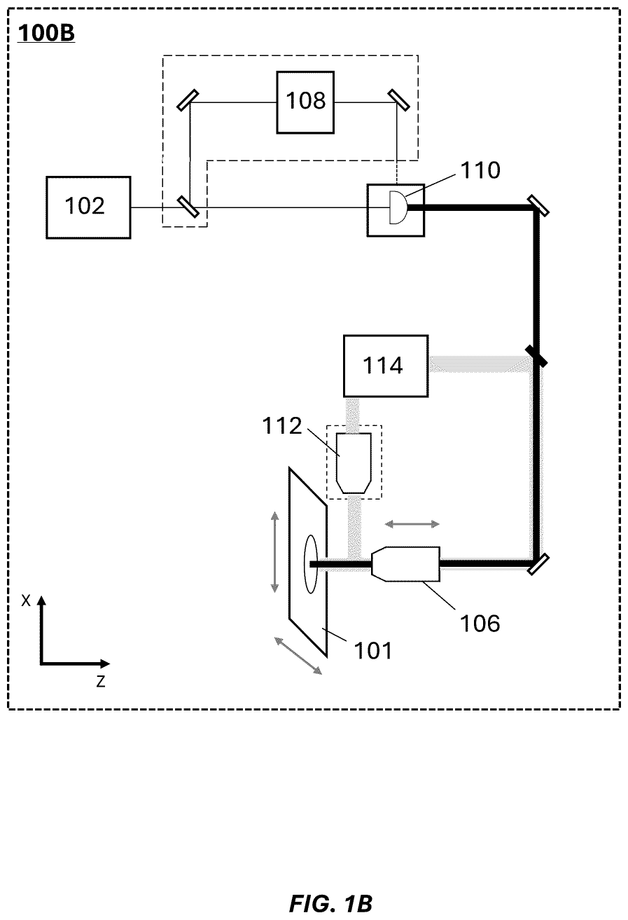

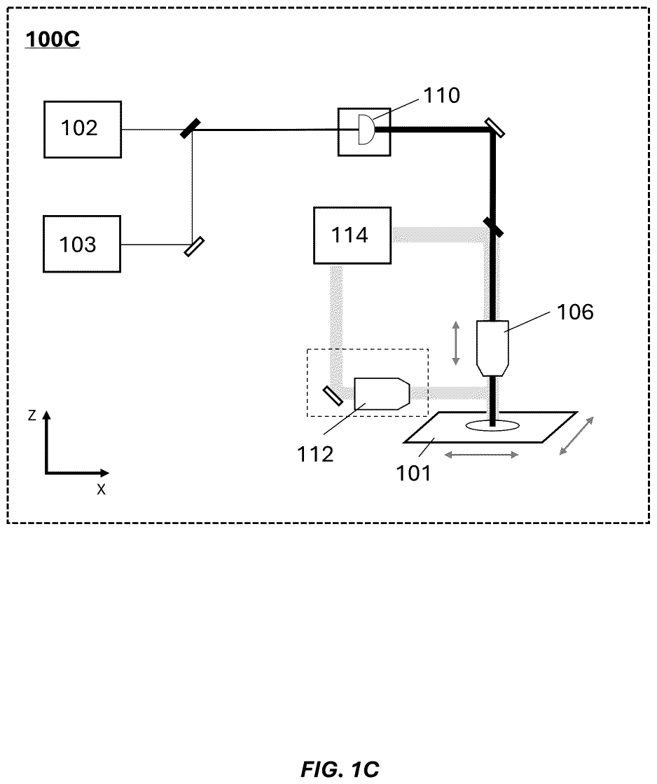

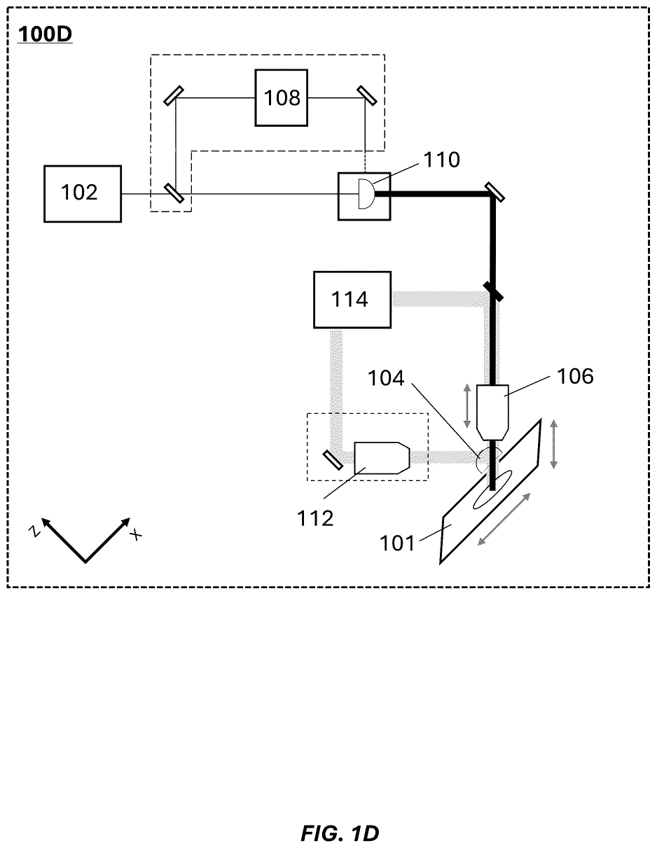

FIGS. 1A-1D are schematic diagrams of non-limiting examples of a system constructed and arranged to generate and measure fluorescence using one or both of visible and IR wavelengths that irradiate a sample. In FIGS. 1A-1D, system 100A, 100B, 100C, and 100D include a light source 102 configured to produce a light beam having a wavelength range. A laser light source is preferably used as a light source, such as a pulsed laser or a continuous-wave (CW) laser. The light source may, however, also be an LED or a lamp. In embodiments with an LED light source, the light source 102 may include any number of additional components to form a collimated, spectrally filtered beam from the nominally incoherent LED. For example, the light source 102 can include pinhole filters, gratings, slit-based devices, metasurfaces, spatial light modulators, digital micromirror devices, and other related technologies.

In embodiments where LEDs are the light source 102, the light source 102 can include a plurality of LEDs such that there is sufficient intensity for irradiation of the sample. The plurality of LEDs can be combined into a single beam using one or more optical components, such as dichroic mirrors, reverse operated beamsplitters, laser beam combiners, and the like. The light source 102 can be a source of visible light or a source of IR light. The wavelength range of the light source is chosen to produce a population of excited singlet states derived from relaxation of a population of higher-order triplet states in the sample. The light source 102 can be a fixed frequency source of either visible light or IR light. Alternatively, the light source 102 can be a tunable frequency source of visible light, such as a supercontinuum light source. As used herein, “supercontinuum light” refers to a white light source that spans a range of about 400 nm to about 2400 nm in the electromagnetic spectrum. Should supercontinuum light be used as the light source 102, the light beam from light source 102 can be directed to an optional filter 108, illustrated in a dashed line box denoting optional, that can pass a desired wavelength of either visible or IR light. The optional filter 108 can be an acousto-optic tunable filter (AOTF), e.g., a filter including a single acousto-optic crystal, a single acoustic wave transducer bonded on a selected surface of the acousto-optic crystal and a radio frequency signal source, or a linear variable filter. In supercontinuum-based systems, the selection of an output wavelength can be performed using an on-board controller built into the supercontinuum laser. In other cases, the selection of an output wavelength can be set using a control system or software operatively coupled to the supercontinuum laser. In this configuration, a user or operator can select a wavelength, and a series of filters, gratings, or crystals, e.g., birefringent crystals, coupled to motors can be actuated to provide the correct output, i.e., the motor positions are calibrated for particular wavelengths. Other configurations of automatic adjustments of the output of a supercontinuum laser are within the scope of this disclosure.

In some embodiments of the systems disclosed in FIGS. 1A-1C, when the light source is visible light, the visible wavelength range may be from about 400 nm to about 700 nm, e.g., about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, or about 700 nm.

In some embodiments of the systems disclosed in FIGS. 1A-1C, when the light source is IR light, the IR wavelength range may be from about 750 nm to about 1000 nm, e.g., about 750 nm, about 760 nm, about 770 nm, about 780 nm, about 790 nm, about 800 nm, about 810 nm, about 820 nm, about 830 nm, about 840 nm, about 850 nm, about 860 nm, about 870 nm, about 880 nm, about 890 nm, about 900 nm, about 910 nm, about 920 nm, about 930 nm, about 940 nm, about 950 nm, about 960 nm, about 970 nm, about 980 nm, about 990 nm, or about 1000 nm.

In the embodiment of the system 100C illustrated in FIG. 1C, the system 100C includes a second light source 103. In this configuration, the system 100C is constructed and arranged for two-color, multiphoton excitation. For example, in a two-light source system, the first light source 102 can be visible and the second light source 103 can be visible. Systems such as system 100C illustrated in FIG. 1C can include three independent light sources or four independent light sources. The inclusion of three or four independent light sources into systems such as system 100C illustrated in FIG. 1C provides for multiplexed fluorescence imaging, i.e., the ability to see more than one signal at a time, in an individual sample such that relationships between the different optical signals can be ascertained. In other embodiments, first light source 102 can be IR and the second light source 103 can be IR. The system 100C can also be used to do multiphoton excitation in different parts of the electromagnetic spectrum. For example, the first light source 102 can be visible and the second light source 103 can be IR. In another embodiment, the first light source 102 can be IR and the second light source 103 can be visible.

With continued reference to FIGS. 1A-1D, system 100A, 100B, 100C, 100D includes an optical assembly 110 constructed and arranged to converge the light beam to form an optical sheet. In general, optical sheets are formed using one or more beam expanding or shaping lenses, such as a cylindrical lens, a Powell lens, a grating, a spatial light modulator, a digital micromirror device, or tube lenses. In various embodiments, the optical assembly is configured to provide annular pupil illumination, i.e., an annular amplitude and/or phase distribution at the pupil, to generate “propagation-invariant” beams, such as a Bessel beam. The annular distribution can be produced by a beam-shaping module using one or more elements, such as a ring aperture or annular stop, an annular mask, an axicon, a programmed spatial light modulator pattern, a diffractive optical element, a digital micromirror device, or a grating that apodizes the pupil. For example, as illustrated in FIGS. 1A-1D, optical assembly 110 includes a cylindrical lens or a Powell lens. Alternatively, the excitation light sheet can be created by scanning a beam with a mirror galvanometer or resonant scanner. A light sheet using a mirror galvanometer or resonant scanner is formed by scanning in one dimension at least once during the exposure of the detector, e.g., a camera sensor. In other embodiments, the excitation light sheet can be created by a grating, spatial light modulator, or digital micromirror device to spatially disperse the spectrum of a laser pulse. The resulting spatially disperse beam spot can be optically relayed to the sample via a telescope, e.g., an objective and lens. In this configuration, a laser pulse is formed in which its spectral components overlap in space and time only at the focal plane, thereby confining nonlinear excitation axially.

Optical assembly 110 can include other components for directing a light beam from the light source 102 into the optical assembly 110 or for directing the optical sheet out of optical assembly 110. This includes, but is not limited to, adjustable slit diaphragms, lenses, telescopes, periscopes, mirrors, scanning mirror galvanometers, lenses, dichroic filters, or combination thereof, and optionally one or more additional filters, polarizers, beamsplitters, or other optical components. In a non-limiting embodiment, the optical sheet that is formed can be dithered by an additional mirror galvanometer. In this configuration, the additional mirror galvanometer increases illumination uniformity and reduces shadowing from sample-induced absorption and scattering. In another non-limiting embodiment, the optical sheet that is formed can be translated orthogonally to the beam axis to irradiate a different portion of the sample.

In some embodiments, the output power of any light source disclosed herein, e.g., light source 102 and/or light source 103, is from about 1 kW/mm² to about 100 kW/mm², e.g., about 1 kW/mm² to about 10 kW/mm², about 5 kW/mm² to about 150 kW/mm², about 10 kW/mm² to about 30 kW/mm², about 20 kW/mm² to about 40 kW/mm², about 30 kW/mm² to about 50 kW/mm², about 40 kW/mm² to about 60 kW/mm², about 50 kW/mm² to about 70 kW/mm², about 60 kW/mm² to about 80 kW/mm², about 70 kW/mm² to about 90 kW/mm², or about 80 kW/mm² to about 100 kW/mm². In some embodiments, the output power of one or both of the first IR light beam and the second IR light beam may be about 1 kW/mm², about 2 kW/mm², about 3 kW/mm², about 4 kW/mm², about 5 kW/mm², about 6 kW/mm², about 7 kW/mm², about 8 kW/mm², about 9 kW/mm², about 10 kW/mm², 11 kW/mm², about 12 kW/mm², about 13 kW/mm², about 14 kW/mm², about 15 kW/mm², about 16 kW/mm², about 17 kW/mm², about 18 kW/mm², about 19 kW/mm², about 20 kW/mm², 12 kW/mm², about 22 kW/mm², about 23 kW/mm², about 24 kW/mm², about 25 kW/mm², about 26 kW/mm², about 27 kW/mm², about 28 kW/mm², about 29 kW/mm², about 30 kW/mm², 31 kW/mm², about 32 kW/mm², about 33 kW/mm², about 34 kW/mm², about 35 kW/mm², about 36 kW/mm², about 37 kW/mm², about 38 kW/mm², about 39 kW/mm², about 40 kW/mm², 41 kW/mm², about 42 kW/mm², about 43 kW/mm², about 44 kW/mm², about 45 kW/mm², about 46 kW/mm², about 47 kW/mm², about 48 kW/mm², about 49 kW/mm², about 50 kW/mm², 51 kW/mm², about 52 kW/mm², about 53 kW/mm², about 54 kW/mm², about 55 kW/mm², about 56 kW/mm², about 57 kW/mm², about 58 kW/mm², about 59 kW/mm², about 60 kW/mm², 61 kW/mm², about 62 kW/mm², about 63 kW/mm², about 64 kW/mm², about 65 kW/mm², about 66 kW/mm², about 67 kW/mm², about 68 kW/mm², about 69 kW/mm², about 70 kW/mm², 71 kW/mm², about 72 kW/mm², about 73 kW/mm², about 74 kW/mm², about 75 kW/mm², about 76 kW/mm², about 77 kW/mm², about 78 kW/mm², about 79 kW/mm², about 80 kW/mm², 81 kW/mm², about 82 kW/mm², about 83 kW/mm², about 84 kW/mm², about 85 kW/mm², about 86 kW/mm², about 87 kW/mm², about 88 kW/mm², about 89 kW/mm², about 90 kW/mm², 91 kW/mm², about 92 kW/mm², about 93 kW/mm², about 94 kW/mm², about 95 kW/mm², about 96 kW/mm², about 97 kW/mm², about 98 kW/mm², about 99 kW/mm², or about 100 kW/mm².

Following shaping of the light beam into an optical sheet, system 100A, 100B, 100C, 100D includes an objective 106 that is disposed to illuminate a sample stage 101 with the optical sheet. The objective 106 can illuminate the sample with a single color of light, e.g., system 100A and 100B, or can co-illuminate the sample, e.g., system 100C. In other embodiments, system 100A, 100B, 100C includes dual illumination objectives positioned in opposing directions. In this configuration, the combination of two illumination objectives increases illumination uniformity over a larger area and improves resulting image quality. The objective 106 can be translated along one or more of the three nominal coordinate axes, i.e., X-, Y-, or Z-axis, to move the optical sheet over the sample on sample stage 101, as illustrated by the arrows near objective 106 in FIGS. 1A-1D. Alternatively, or in addition, the sample stage 101 can be translated along one or more of the three nominal coordinate axes, i.e., X-, Y-, or Z-axis, to move the optical sheet over the sample on the sample stage 101 as illustrated by the arrows near sample stage 101 in FIGS. 1A-1D. In either configuration, the sample stage 101 and the (first) objective 106 are generally constructed and arranged to translate in a direction orthogonal to a beam axis of the optical sheet irradiating the sample. In further embodiments, the sample stage 101 and the (first) objective 106 can be constructed and arranged to move at angles greater than or less than 90° relative to the beam axis of the optical sheet irradiating the sample. The movable sample stage 101, movable objective 106, and/or optical assembly 110 allows the optical sheet to scan over a linear plane of the sample.

Following interaction of the sample with the optical sheet, the resulting effects, e.g., fluorescence, can be detected or observed. For systems 100A, 100B, 100C, 100D that do not include any specific detector, the resulting irradiation of the sample by the combined IR beam may be observed in a downstream process. For example, samples that do not fluoresce, phosphoresce, or otherwise emit photons upon irradiation with the optical sheet may be polymerized, degraded, physically, and/or chemically altered or modified. As a non-limiting example, a photoresist that is sensitive to visible or IR light will transfer the desired pattern to a substrate the photoresist is applied to upon irradiation with the optical sheet without emitting photons. In other embodiments, such as that illustrated in FIGS. 1A-1D, photon emissions may be observed by a detector 114 that is configured to receive a signal representative of fluorescence in the sample and to provide an output representative thereof. As illustrated in FIGS. 1A-1C, the signal representative of fluorescence can be transmitted to detector 114 along the same optical axis as the optical sheet, i.e., directed back through objective 106 and to detector 114. In an alternative configuration, system 100A, 100B, 100C, 100D can include an optional off-axis second objective 112, shown in a dashed line box, disposed orthogonal to the objective 106. In this configuration, a signal representative of fluorescence from the sample is collected by second objective 112 and directed to the detector 114.

The orientation of the objective 106 and the sample stage 101 can be set to illuminate the sample from a preferred plane. For example, as illustrated in FIGS. 1A and 1C, the objective 106 is positioned vertically above the sample stage 101. In another embodiment, such as that illustrated in FIG. 1B, the objective 106 is positioned in a plane parallel to the sample stage 101. In configurations where a second objective 112 is utilized as an off-axis light collector for the detector 114, the (first) objective 106 and second objective 112 are maintained orthogonal to each other. The pair of the (first) objective 106 and second objective 112 can be moved together at any angle that permits imaging of the sample with the optical sheet while maintaining the orthogonality of the (first) objective 106 and second objective 112. In addition, another, e.g., third, or fourth if dual-illumination objectives are used, detection objective oriented orthogonal to the optical sheet can be used for multiview imaging, to increase the collection cone angle and information content, thereby improving axial resolution and image quality. Other configurations between the objectives, sample stage, and detector are within the scope of this disclosure.

In another embodiment, as illustrated in FIG. 1D, the objective 106 is positioned obliquely to the sample stage 101. In configurations where a second objective 112 is utilized as an off-axis light collector for the detector 114, the first objective 106 and second objective 112 are maintained orthogonal to each other, creating an open-top system, akin to a traditional inverted microscope. The pair of the first objective 106 and second objective 112 can be moved together at any angle that permits imaging of the sample with the optical sheet while maintaining the orthogonality of the first objective 106 and second objective 112. This configuration can include a meniscus lens or solid-immersion lens 104, positioned between the first and second objective and sample, to aid in optical sheet generation. Without wishing to be bound by any particular theory, a meniscus or solid-immersion lens serves, at least in part, to minimize aberrations when coupling both the illumination and collection beams into and out of glass, e.g., for a high-throughput system designed for microscope slides or multi-well plates. The curved surface of the meniscus or solid-immersion lens approximates the wavefront curvature of light beams at an interface, e.g., glass-to-water and water-to glass, thus helping to preserve beam and image quality across transitions between the glass, immersion media, and/or sample.

Typical two-photon microscopy excites a fluorescent molecule from the ground state (S₀) to the first excited singlet state (S₁) by transiently populating a virtual state in between with visible or IR photons. As disclosed herein, directly accessing the first excited triplet state (T₁), which is lower in energy than the S₁ state, from the S₀ state can be achieved using visible or IR wavelengths with one or both of higher light source power or light beams that have the transverse profile of the incident light shaped to better match the magnetic dipole transition selection rules, e.g., azimuthal polarization. In system 100A, 100B, 100C, 100D of FIGS. 1A-1D, the population of triplet states in the fluorescent molecules in the sample is produced by exciting magnetic dipole transitions in the fluorescent molecules using the optical sheet. Once the population of triplet states T₁ is produced from the excitation of magnetic dipole transitions in the sample, the population of transient higher-level excited triplet states (Tₙ) can be produced by continued illumination with the optical sheet. The population of higher-level excited triplet states will, through reverse intersystem crossing, form the population of excited singlet states (S1). As disclosed herein, reverse intersystem crossing (RISC) is a process of energy transfer from triplet states to excited singlet states. Generally, RISC occurs from the T₁ state to the S₁ of a molecule according to Kasha's Rule but has also been shown to occur between higher-level excited triplet states (Tₙ) and the S₁ state. By populating higher-level excited triplet states Tₙ with the optical sheet, those states can relax through RISC to produce the population of excited singlet states, thus providing a mechanism for studying transitions typically “forbidden” by electric dipole selection rules.

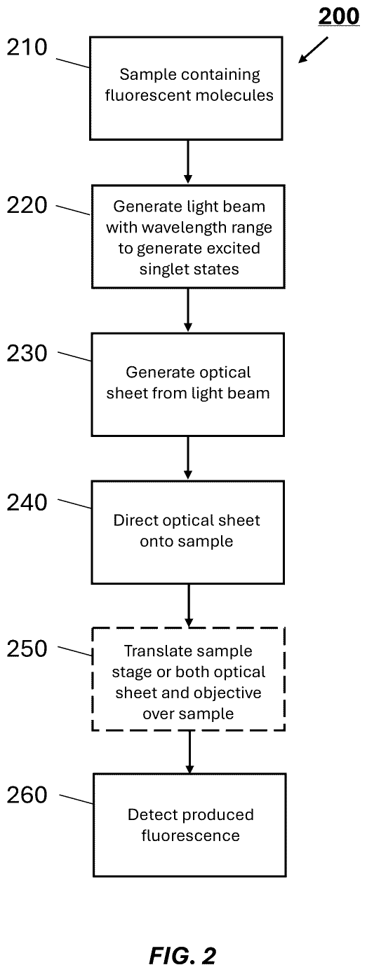

FIG. 2 illustrates a flow diagram of one non-limiting example of a method of irradiating a sample according to certain embodiments disclosed herein. The method 200 begins at step 200 with preparation of an initial sample, e.g., a sample containing molecules that can fluoresce under certain irradiation conditions. Suitable samples can include, but are not limited to, any inorganic, organic, or biological sample in an appropriate medium, such as fluorescent dyes, fluorescent biomolecules, photoresist chemicals, polymerizable resins, phosphors, acenes, coumarins, quantum dots, metal-organic frameworks (MOFs), and polymers. In some embodiments, a biological sample can be a living cell or a living organism, such as a laboratory animal. In step 220, a light beam with a wavelength range that can generate excited singlet states is produced from the light source. In step 230, an optical sheet is formed from the light beam using appropriate optics, e.g., a cylindrical lens, a Powell lens, and/or a scanning mirror galvanometer. For example, a cylindrical lens or a Powell lens in an optical assembly can form an optical sheet from a substantially circular light beam, e.g., from a laser. Alternatively, a galvanometer mirror or resonant scanner in an optical assembly can rapidly scan a substantially circular light beam to form an optical sheet as viewed by the photosensitive detector. As another example, a grating, spatial light modulator, or digital micromirror device can spatially disperse the spectrum of a laser pulse which can be refocused in time and space to form a light sheet.

In step 240, the optical sheet is directed to the sample, e.g., using an objective. Irradiation of the sample with the light sheet causes certain optical transitions, e.g., formation of an initial population of triplet states in the sample upon irradiation by the optical sheet and excitation of the initial population of triplet states in the sample to the higher-order triplet states, in the sample, e.g., transitions from the S₀ state to the T₁ state and transitions from the T₁ state to the S₁ state via population of higher energy transient Tₙ states and RISC down to the S₁ state.

To image the sample, a sample stage holding the sample or both the optical sheet and detection objective can be translated or moved over the sample at step 250. The emissions from the excitation process are detected by a suitable photosensitive detector coincident with the optical sheet at step 260. In some embodiments, a meniscus or solid-immersion lens can aid other appropriate excitation and detection optics in forming and detecting a reduced-aberration optical sheet when imaging through glass substrates.

In some embodiments, when the light source is visible light, the visible wavelength range may be from about 400 nm to about 700 nm, e.g., about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, or about 700 nm.

In some embodiments, when the light source is IR light, the IR wavelength range may be from about 750 nm to about 1000 nm, e.g., about 750 nm, about 760 nm, about 770 nm, about 780 nm, about 790 nm, about 800 nm, about 810 nm, about 820 nm, about 830 nm, about 840 nm, about 850 nm, about 860 nm, about 870 nm, about 880 nm, about 890 nm, about 900 nm, about 910 nm, about 920 nm, about 930 nm, about 940 nm, about 950 nm, about 960 nm, about 970 nm, about 980 nm, about 990 nm, or about 1000 nm.

In accordance with an aspect, there is provided a system for irradiating a sample. The system includes a first light source configured to produce a first light beam having a first wavelength range to produce a first population of triplet states in the sample. The system includes a second light source configured to produce a second light beam having a second wavelength range to produce a population of excited singlet states in the sample. The system further includes an optical assembly disposed to combine the first light beam and second light beam to create a combined light beam that forms an optical sheet. The system additionally includes a first objective constructed and arranged to irradiate the sample with the optical sheet.

In some embodiments, the first light source is a visible light source. In some embodiments, the second light source is a visible light source.

In some embodiments, the first light source is a visible light source. In some embodiments, the second light source is an IR light source,

In some embodiments, the first light source is an IR light source. In some embodiments, the second light source is a visible light source.

In some embodiments, the first light source is an IR light source. In some embodiments, the second light source is an IR light source.

In some embodiments, the visible wavelength range is between about 400 nm to about 700 nm. In some embodiments, the IR wavelength range is between about 750 nm to about 1000 nm.

In some embodiments, the optical assembly includes a cylindrical lens that forms the optical sheet from the combined light beam.

In some embodiments, the optical assembly includes a Powell lens that forms the optical sheet from the combined light beam.

In some embodiments, the optical assembly includes one or more scanning mirror galvanometers that form the optical sheet from the combined light beam and/or translate the sheet orthogonally to the propagation axis.

In some embodiments, the optical assembly includes a grating that forms the optical sheet from the combined light beam.

In some embodiments, the optical assembly includes a meniscus or solid-immersion lens.

In accordance with an aspect, there is provided a system for irradiating a sample. The system includes a visible light source configured to produce a visible light beam having a visible wavelength range to produce a population of excited singlet states derived from relaxation of a population of higher-order triplet states in the sample. The system includes an optical assembly constructed and arranged to converge the visible light beam to form an optical sheet. The system further includes a first objective constructed and arranged to irradiate the sample with the optical sheet.

In some embodiments, the visible wavelength range is between about 400 nm to about 700 nm. In specific embodiments, the visible wavelength range is about 660 nm.

In some embodiments, the optical assembly includes a cylindrical lens that forms the optical sheet from the visible light beam.

In some embodiments, the optical assembly includes a Powell lens that forms the optical sheet from the visible light beam.

In some embodiments, the optical assembly includes one or more scanning mirror galvanometers that form the optical sheet from the combined light beam and/or translate the sheet orthogonally to the propagation axis.

In some embodiments, the optical assembly includes a grating that forms the optical sheet from the combined light beam.

In some embodiments, the optical assembly includes a meniscus or solid-immersion lens.

### EXAMPLES

The function and advantages of these and other embodiments of this disclosure can be better understood from the following examples. These examples are intended to be illustrative in nature and are not considered to be in any way limiting the scope of the invention.

### Example 1—High-Resolution Large Volumetric Imaging of Organoids

3D cell culture systems, such as spheroids or organoids, more faithfully recapitulate the native physiology of multicellular tissues than 2D cultures. Even simple stem cell aggregates can break symmetry to form organ-and embryo-like structures in vitro. Recent advances in stem cell-based models have rapidly expanded the complexity and diversity of self-organizing systems, from gastruloids to patient-derived tumor organoids. However, understanding their collective behavior and spatiotemporal organization is challenging with standard light microscopes due to their dense, scattering, and aberrating nature. Further, these multicellular systems rely on intricate biochemical signaling, mechanical interactions, and continuous cellular rearrangements involving tens of thousands of cells over days to weeks, demanding gentle, high spatiotemporal resolution imaging across hundreds of microns in 3D.

Light-sheet microscopy has emerged as a powerful method for multiscale imaging of living systems. Illuminating only the plane of interest provides fast volumetric acquisition, low out-of-focus background, and minimal photodamage, e.g., phototoxicity and photobleaching, of samples, enabling long-term imaging of the most delicate of samples for durations of hours or longer. These advantages have enabled applications for developmental biology, permitting the reconstruction of hundreds of thousands of cells in space and over time in a range of multicellular systems, including zebrafish, fruit flies, and mice.

Despite recent advances in light-sheet microscopy, more established methods still exhibit restrictions with respect to sample mounting, field of view, and imaging depth which hampers faithful quantitative analysis of organoid samples. For example, images of organoids at the single-cell level have been reported using an open-top multi-view imaging system with a custom-designed multi-well holder that is restricted to only four samples. Restrictions on sample holder limits throughput, which is a problem that becomes more severe with longer imaging durations. Further, while superficial regions of the 3D specimen are clear, deeper, e.g., approximately 25 μm, regions are hazy, compromising the tracing and quantification of cellular fates.

Two-photon light-sheet microscopy will improve the penetration depth of conventional light-sheet microscopy. Two-photon light-sheet microscopy has shown utility in the imaging of thick and optically dense samples, imaging up to two times deeper than conventional light-sheet microscopy. Two-photon light-sheet microscopy has also shown a greater than ten times faster acquisition speed and one hundred times lower peak intensity than conventional two-photon point-scanning microscopy. While two-photon light-sheet microscopy has improved imaging of biologically relevant samples, it does have a number of disadvantages. For example, two-photon light-sheet microscopy to date has been limited by the high cost of ultrafast lasers, lower fluorophore absorption cross section, which has led to lower maximum imaging speed, a lower amenability to simultaneous multicolor imaging, and the increased probability of nonlinear photodamage mechanisms.

Combining the fluorescence mechanism disclosed herein, i.e., direct access to the first excited triplet state and accessible higher-order triplet states Tₙ, n>1, with light-sheet illumination is poised to overcome the drawbacks of conventional two-photon light-sheet microscopy. As used herein, “2P′” denotes triplet-access excitation where there is a nonlinear dependence of the fluorescence signal(S) on the illumination intensity (I), e.g., S∝I^{x}, x≥1.6; “2P” denotes conventional two-photon excitation; and “1P” denotes one-photon excitation. By enabling the use of lower cost picosecond pulsed and continuous-wave light sources, triplet state multiphoton light-sheet microscopy will become more accessible and compatible with the simultaneous imaging of multiple endogenous and exogenous labels in biological samples. The use of picosecond pulses instead of femtosecond pulses to create a nonlinear excitation light sheet further will reduce peak power by at least two orders of magnitude for the same average power (assuming a two order of magnitude longer pulse duration). Picosecond pulses will significantly lower nonlinear, e.g., supra-quadratic, photodamage of samples. In a manner similar to traditional 2P light-sheet microscopy, the reduction in peak power will allow for higher tolerable average power. It is estimated that the average power can be increased by at least five times before reaching nonlinear photodamage, yielding, at a minimum, an approximately thirteen times fluorescence signal enhancement for higher signal-to-noise or faster imaging compared to t2P light-sheet microscopy. Similar enhancements in fluorescence signal are expected for continuous-wave light sources where the peak power equals the average power. With the substantially lower peak power required for directly accessing the first excited state and higher-order triplet states, linear photon absorption becomes the practical limiting factor. The shorter wavelengths, e.g., 665 nm, used in the fluorescence mechanism disclosed herein is further from the water absorption band compared to the near IR light used in conventional 2P, which should minimize thermal effects as the average power increases.

It is believed that additional gains in 2P light-sheet microscopy using the fluorescence mechanism disclosed herein, i.e., 2P′, will be achieved by decreasing the laser repetition rate. An approximately 80 MHz repetition rate is commonly used for nonlinear bioimaging. However, this repetition rate is suboptimal for 2P light-sheet microscopy due to the lower illumination numerical aperture (NA) and orthogonal geometry of the excitation and illumination objectives. As 2P light-sheet microscopy has demonstrated an improved overall fluorescence excitation efficiency, the 2P′ light-sheet approach disclosed herein should improve the performance of 2P light-sheet microscopy by an order of magnitude or more in signal and speed, retaining the benefit of depth-enhanced optical sectioning. These enhancements will extend the ability of light-sheet microscopy to resolve single cells deep within large organoids and embryos, e.g., 500 μm and greater.

Organoids are in principle powerful models for high-throughput experiments, e.g., pharmacological screens, as hundreds can be routinely generated in an individual experiment. Deep, fast, and spectrally versatile multi-scale imaging compatible with multi-well plate assays using 2P′ light-sheet microscopy with the fluorescence mechanism disclosed herein will provide rapid and robust methods to quantitatively characterize the cellular behavior of patient-derived organoids in response to therapeutics.

In general, the resolution for cellular-resolution imaging is more relaxed than for other imaging experiments. Due to this relaxation, wide-field temporal focusing using a single objective at the sample, which supports high-throughput imaging of multi-well plates, is possible. By using a grating, spatial light modulator, or digital micromirror device to spatially disperse the spectrum of a laser pulse, and optically relaying the resulting beam spot to the sample via a telescope, e.g., an objective and lens, a laser pulse is formed in which its spectral components overlap in space and time only at the focal plane, thereby confining nonlinear excitation axially. The axial extent of the beam is governed by the degree of spectral dispersion, while the lateral extent is determined by the NA and imaging optics, resulting in a temporally focused optical sheet. Wide-field temporal focusing generally exhibits average laser power that scales linearly with the excitation area, which can limit its applications due to sample heating. Under the same experimental conditions, 2P light-sheet microscopy outperforms wide-field temporal focusing in imaging speed, imaging volume size, and noninvasiveness, at the expense of instrument and sample-mounting complexity. While the fluorescence mechanism disclosed herein is compatible with wide-field temporal focusing, it is likely to be more effective in spatial focusing geometries, where its advantages can be more fully leveraged.

### Example 2—Subcellular Imaging of Multicellular Systems

Lattice light-sheet microscopy provides the highest diffraction-limited spatial resolution for commercially available light-sheet microscopy systems to date. Some commercially available systems can provide subcellular resolution at high speed while being noninvasive and compatible with traditional microscope sample mounting, i.e., coverslipped samples on slides, dishes and multi-well plates. These systems operate using a class of propagation-invariant light beams known as 2D optical lattices based on an array of Bessel beams, which produce thin, i.e., approximately ~550 nm to 1.5 μm, and long, i.e., 15 μm to 100 μm, light sheets compared to standard Gaussian beams. In light-sheet microscopy, the lateral resolution is determined by the detection optics and the axial resolution is determined by the light-sheet thickness and detection optics. For thick light sheets, the NA of the detection objective dictates, at least in part, the axial resolution of the system. In the limit where the light sheet is thinner than the depth of field of the detection objective, the axial resolution approaches that of the illumination beam waist such that the 3D spatial resolution can be nearly isotropic. This thickness also determines the degree of rejection of out-of-focus light, i.e., thinner sheets produce higher axial resolution and optical sectioning, surpassing that of point-scanning microscopy.

The useful field of view (FOV) is as large as the region over which the illumination beam or light-sheet thickness (FWHM) is less than or equal to c×FWHMₘᵢₙ, where c is between 1.2 and 1.5. The most common Gaussian light sheets have a cross-sectional profile for which the FOV shrinks quadratically as the beam waist becomes thinner. Because of this, 2 μm to 10 μm thick Gaussian light sheets are typically used for multicellular imaging over large FOVs, providing sufficient optical sectioning for cellular-resolution imaging. When imaging an approximately 50 μm diameter cultured cell, an optimized Gaussian sheet diverges to a thickness of approximately 3 μm at either end. This is approximately three times larger than the high NA detection depth of field. This thickness is too thick over cellular dimensions to benefit subcellular imaging, and consequently rarely reveals as much detail in the axial direction as a confocal microscope. Non-diffracting or propagation-invariant beams theoretically maintain a tight 2D focus throughout an infinite propagation length, overcoming the tradeoff between the light-sheet thickness and the useful field of view.

Together with a high NA, e.g., a NA of 1.0, detection objective, the lattice light sheet provides 330×330×500-1000 (xyz) nm³ raw spatial resolution at speeds of up to 400 frames/s over a 300×20 μm² field of view, i.e., 3 volumes/s, with up to three sequential colors. These attributes make the lattice light sheet excel in rapid imaging of 4D, i.e., 3D Cartesian space and the time dimension, subcellular dynamics in living cells, capturing phenomena inaccessible with wide-field or point-scanning microscopy. Although recent innovations in high-NA oblique plane microscopy can provide comparable performance in a traditional sample mounting format, the lattice light sheet has a simpler optical train with much higher light throughput and system stability. The increased light sensitivity of the lattice light sheet directly translates to a larger photon budget for increasing the signal-to-noise and speed. Further, the simpler optical train provides for a compact and user-accessible platform.

While propagation-invariant beams theoretically decouple the tradeoff between the light-sheet thickness and field of view, such beams are finite in length and contain unwanted sidelobes that grow in magnitude with the propagation length. Thus, under typical experimental conditions, lattice light sheets irradiate the sample with light outside the plane of interest, resulting in increased out-of-focus background, reduced optical sectioning, and unnecessary photodamage. Post-image acquisition deconvolution is often required to reduce blur, restore image contrast, and achieve the full resolution limit of the lattice light sheet, imposing a significant computational cost. Further, as with all forms of linear microscopy, the performance of the lattice light sheet degrades with increasing penetration depth due to absorption, aberrations, and scattering in multicellular systems. Imaging beyond 20 μm to 100 μm retards the lattice light sheet, depending on the optical heterogeneity of the specimen. Lattice light-sheet imaging is thus limited to cultured cells, small, e.g., less than or equal to 100 μm in diameter, transparent embryos or organisms, and small, e.g., less than or equal to 200 μm in diameter, spheroids or organoids.

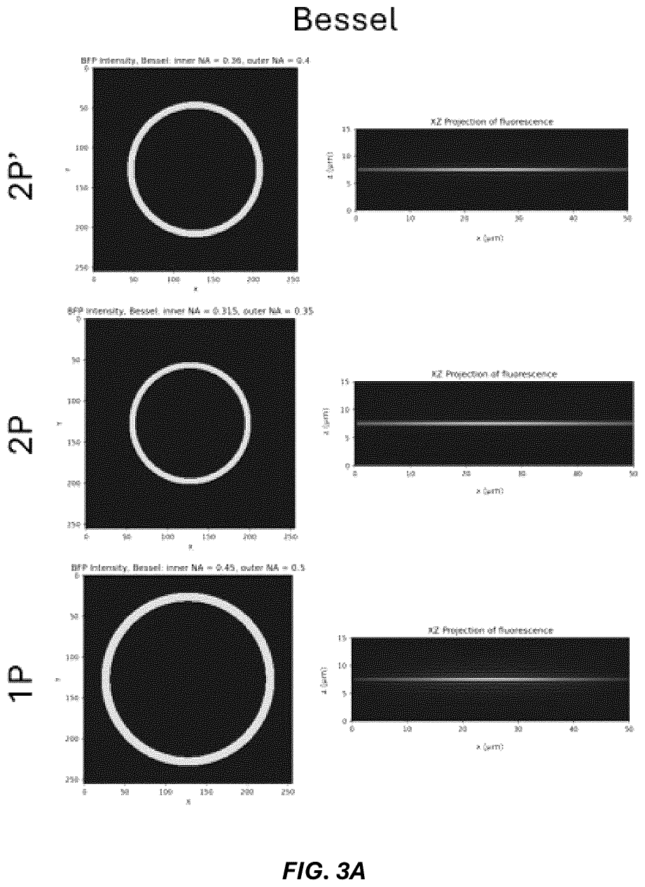

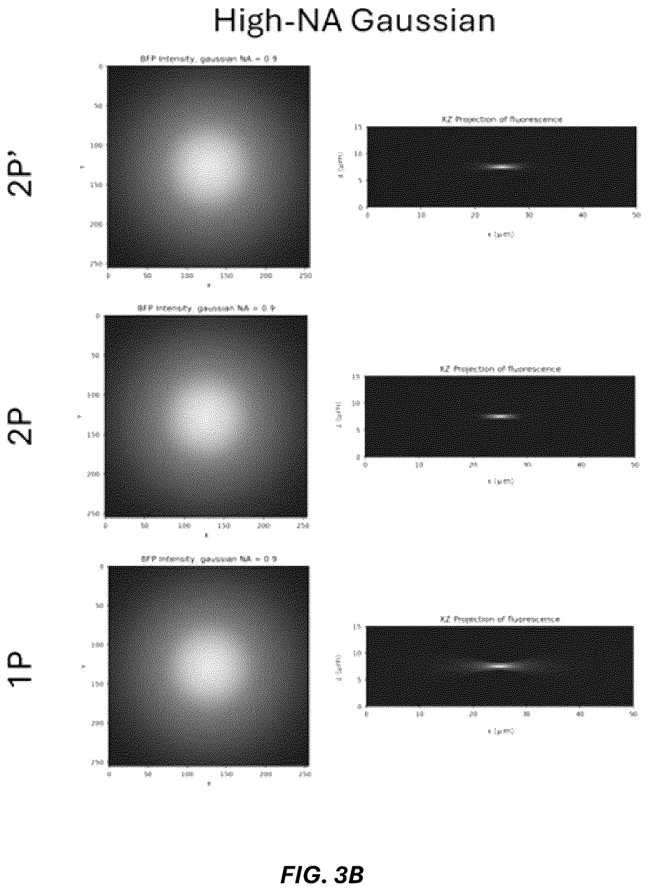

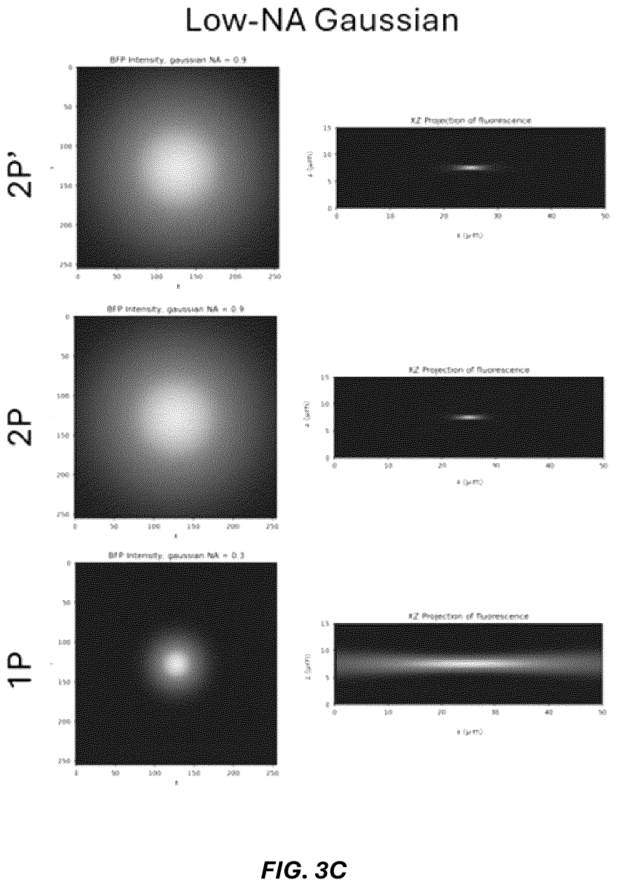

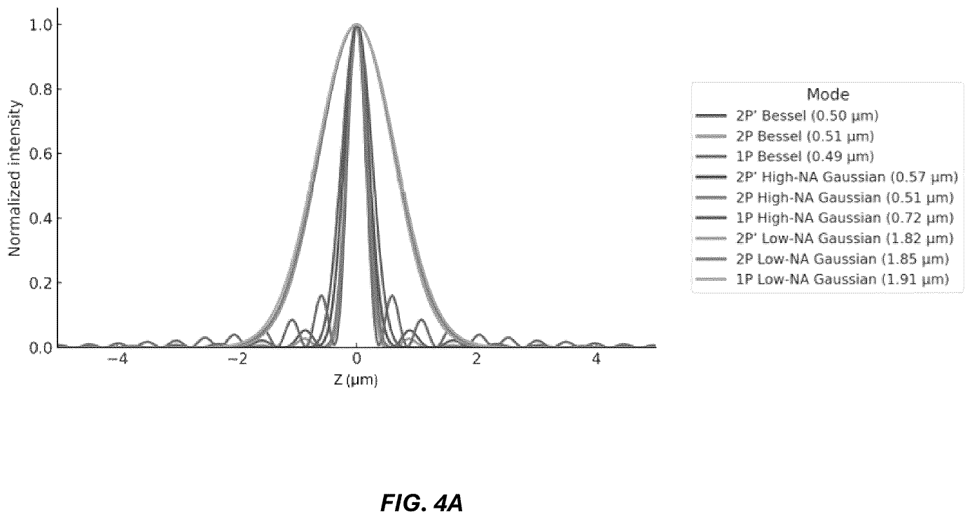

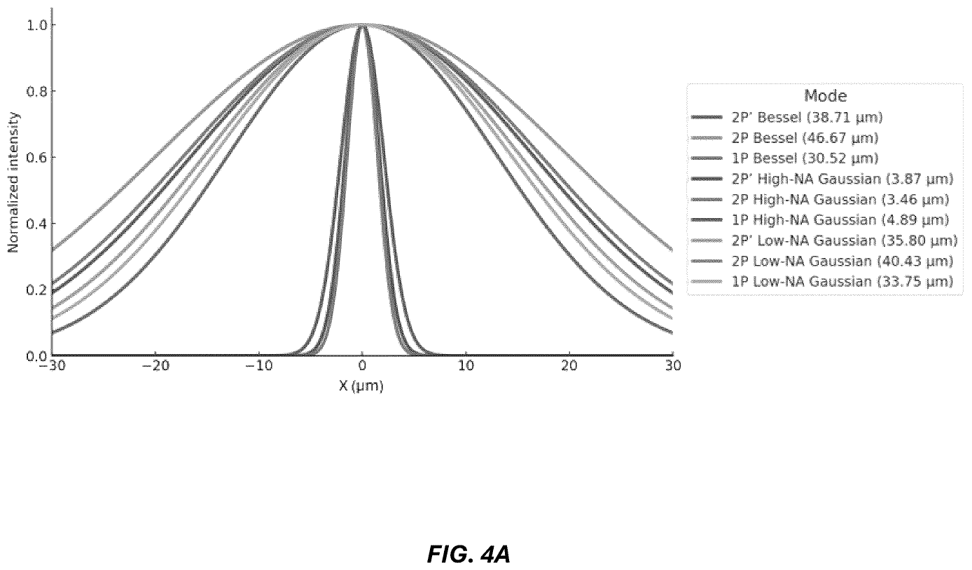

The 2P′ fluorescence mechanism disclosed herein, i.e., direct access to the first excited triplet state and accessible higher-order triplet states Tₙ, n>1, can provide a new class of propagation-invariant beams. The illumination modes referenced herein are conventional high-NA Gaussian beams, conventional low-NA Gaussian beams, and Bessel beams. Numerically simulating 2P′ conditions with S∝I^{1.6} yields a dominant central fluorescence peak where the sidelobes become minimal (see FIGS. 3A-3C, left column of each figure). Measured line profiles (FIGS. 4A-4B) indicate that the fluorescence signal can be constrained to an approximately 500-nm-thick light sheet over FOVs comparable to or larger than Gaussian, Bessel, and lattice light sheets, with substantially reduced out-of-focus fluorescence background. At high detection NA, i.e., NA≥1.0, the resolution is nearly isotropic with an improvement in optical sectioning. Further, fluorescence conditions where the first and higher-order triplet states are accessed would decrease or even eliminate the computational overhead to achieve the system's full resolution limit: less than or equal to 300 nm laterally and 350 nm to 450 nm axially.

Although 2P Bessel beam plane illumination microscopes are commercially available and offer enhanced penetration in specimens that exhibit aberrations and scattering, their adoption has been limited by the high cost of ultrafast lasers, fluorophore constraints, and excessive peak power requirements that preclude imaging speeds comparable to 1P microscopy. In contrast, light sheets using fluorescence conditions where the first and higher-order triplet states are accessed as disclosed herein can provide advantages over conventional 2P light sheets, including lower laser costs, greater than or equal to two orders of magnitude lower peak power from picosecond pulses versus femtosecond pulses, and orders of magnitude higher signal rates from improved fluorescence excitation efficiency and increased tolerable average power. The longer pulse durations are also less susceptible to pulse broadening through glass, which reduces the signal at high NA. As a result, multicolor imaging at substantially faster speeds can be had, potentially operating at the limit of the camera. Generating propagation-invariant light sheets that produce fluorescence by directly accessing the first triplet state and higher-order triplet states can extend fast 5D (4D+color) subcellular imaging to large, densely fluorescent multicellular organisms, a regime inaccessible to any existing modality today.

Propagation-invariant light sheets that directly access the first triplet state and higher-order triplet states can be generated using a plurality of starting systems. Bessel beams would be suitable starting points as illustrated in FIGS. 3A-3C and FIGS. 4A-4B. In addition, other exotic beam types, like the lattice and cosine standing wave, may yield better-suited solutions for directly accessing the first triplet state and higher-order triplet states. While the nonlinear dependence of the fluorescence signal on the excitation intensity will lead to less scattering at depth, aberrations in highly heterogenous specimens will still require correction. Adaptive optical imaging can recover diffraction-limited resolution in such thick specimens.

A system designed for both subcellular and high-throughput imaging will support both standard sample mounting as well as whole-organism or whole-tissue embedding. To facilitate ease of alignment, maintenance, and usability, the optical design prioritizes simplicity and minimizes the number of components. For high-speed imaging of large samples, such as embryos, animals, organoids, and cleared or expanded tissue, a multi-objective geometry that implements 2P′ propagation-invariant light sheets disclosed herein will serve as a powerful platform (FIGS. 1A-1C). For conventional sample formats, i.e., samples mounted on glass substrates, the excitation and emission paths incorporate custom objective lenses paired with free-form optics and a meniscus or solid-immersion lens (FIG. 1D), enabling an open-top design and preserving a streamlined optical train with high light throughput.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A system for irradiating a sample, comprising:
a light source configured to produce a light beam having a wavelength range to produce a population of a first triplet state in the sample via excitation of a ground state in the sample and a population of higher order triplet states in the sample via excitation of a first triplet state in the sample and a population of excited singlet states derived from relaxation of a population of higher order triplet states in the sample;
an optical assembly constructed and arranged to converge the light beam to form an optical sheet; and
a first objective constructed and arranged to irradiate the sample with the optical sheet.

2. The system of claim 1, wherein the light source is a visible light source and/or infrared light source.

3. The system of claim 1, wherein the light source comprises a pulsed light source and/or a continuous-wave light source.

4. The system of claim 1, wherein the optical assembly comprises one or more of a cylindrical lens, a Powell lens, a scanning mirror galvanometer, a grating, a spatial light modulator, and a digital micromirror device, that form the optical sheet from the light beam and translate the sheet orthogonally to the propagation axis.

5. The system of claim 1, further comprising a detection path constructed and arranged to receive a signal representative of fluorescence in the sample and to provide an output representative thereof.

6. The system of claim 1, further comprising a second objective lens positioned on a plane orthogonal to the first objective and constructed and arranged to collect fluorescence from the sample and propagate it to a photosensitive detector.

7. The system of claim 1, wherein the optical assembly further comprises a meniscus or solid-immersion lens.

8. The system of claim 5, wherein the second objective is disposed above, disposed below, in a plane parallel to, or oblique to the sample.

9. The system of claim 8, wherein a sample stage or the second objective is constructed and arranged to translate in a direction orthogonal to a beam axis of the optical sheet irradiating the sample.

10. The system of claim 1, wherein the population of excited singlet states can be populated by the formation of an initial population of triplet states in the sample upon irradiation by the optical sheet and can further be populated by further excitation of the initial population of triplet states in the sample to the higher-order triplet states.

11. The system of claim 1, wherein the optical assembly is configured to form the optical sheet from a propagation-invariant Bessel beam by providing annular-pupil illumination using a beam-shaping module configured to impose an annular amplitude and/or phase distribution at the pupil.

12. The system of claim 11, wherein the beam-shaping module comprises a ring aperture or annular stop.

13. The system of claim 11, wherein the beam-shaping module comprises a spatial light modulator, a diffractive optical element, a digital micromirror device, or a grating.

14. A method of irradiating a sample, comprising:
generating a light beam having a wavelength range chosen to produce a population of a first triplet state in the sample via excitation of a ground state in the sample and a population of higher order triplet states in the sample via excitation of a first triplet state in the sample and a population of excited singlet states derived from relaxation of a population of higher order triplet states in the sample;
generating an optical sheet from the light beam; and
applying the optical sheet to the sample using a first objective to produce a population of triplet states and a population of excited singlet states in the sample.

15. The method of claim 14, further comprising detecting fluorescent emissions from relaxation of the population of excited singlet states in the sample with a detection path comprising a second objective lens positioned on a plane orthogonal to the first objective and constructed and arranged to further propagate fluorescence to a photosensitive detector.

16. The method of claim 15, comprising translating a sample stage or both the second objective and optical sheet orthogonally to the beam axis to irradiate a different portion of the sample.

17. The method of claim 14, wherein the population of excited singlet states can be populated by the formation of an initial population of triplet states in the sample and/or can further be populated by further excitation of the initial population of triplet states in the sample to the higher-order triplet states.

18. A system for irradiating a sample, comprising:
a first light source configured to produce a first light beam having a first wavelength range to produce a first population of triplet states in the sample via excitation of a ground state in the sample;
a second light source configured to produce a second light beam having a second wavelength range to produce a population of excited singlet states derived from relaxation of a population of higher order triplet states in the sample;
an optical assembly disposed to combine the first light beam and second light beam to create a combined light beam that forms an optical sheet; and
a first objective constructed and arranged to irradiate the sample with the optical sheet.

19. The system of claim 18, wherein one or both of the first and second light sources are visible or infrared sources or combinations thereof, and the optical assembly includes a dichroic combiner.

20. The system of claim 18, wherein the combined light beam is shaped by at least a cylindrical lens, Powell lens, scanning mirror galvanometer, grating, spatial light modulator, digital micromirror device, ring aperture, annular stop, and/or meniscus lens to form the optical sheet and translate the sheet orthogonally to the propagation axis.
